(19) United States
(12) Patent Application Publication
(10) Pub. No.: US 2017/0298927 A1
(43) Pub. Date: Oct. 19, 2017

(54) FOOD PUMP

(71) Applicant: Marlen International, Inc., Riverside, MO (US)

(72) Inventor: Terry Mawby, Paola, KS (US)

(21) Appl. No.: 15/132,007

(22) Filed: Apr. 18, 2016

(51) Int. Cl. F04B 49/22; F04B 53/16; F04B 17/03; A22C 11/06; F04B 23/02; F04B 19/22; F04B 53/10; F04B 53/14

(52) U.S. Cl. CPC F04B 49/22; F04B 53/10; F04B 53/16; F04B 53/14; A22C 11/06; F04B 23/025; F04B 19/22; F04B 17/03; F04B 2201/06

(57) ABSTRACT

A pumping unit (20) includes a hopper assembly (24) for holding material to be pumped, a pair of identical pumping assemblies (26, 28), and a pumped material outlet (30). The assemblies (26, 28) include directional or spool valves (54) having rotatable spools (76), tubular pumping chambers (56), and pistons (122) within the chambers (56). The pistons (122) include concave operating faces (134), which are complemental and mate with the outer surfaces of the spools (76). Operation of the unit (20) creates successive charges of pumped materials having a minimum of disruptions, such as tearing or smearing.

### BACKGROUND OF THE INVENTION

### Field of the Invention

The present invention is broadly concerned with improved pumping units of the type specifically designed for handling of food products, in order to accurately pump such products with a minimum of product disruption, such as smearing or tearing of meat products. More particularly, the invention is concerned with such pumping units, and the pumping assemblies forming a part thereof, which include features assuring minimal product disruptions with high pumping speeds and accurate pumping rates.

### Description of the Prior Art

U.S. Pat. No. 5,479,847 describes a highly successful commercial food pump manufactured and sold by Marlen International, Inc. The pump described in the '847 patent includes an upright hopper which receives incoming food materials to be pumped. The materials pass from the hopper into a common internal chamber. A pair of shiftable sleeves within the chamber reciprocate in an alternating, fore-and-aft manner to form respective charges of food materials within each sleeve. As each sleeve is filled, an associated piston is used to force the food charge out of the pump and into an outlet assembly having a central rotatable valve. This pump can thus be operated in a batch-continuous fashion to deliver food products to downstream processing devices.

In some instances, it has been found that the pump of the '847 patent can lead to tearing or smearing of food products, particularly in the case of meats. This is believed to result from the use of the reciprocating sleeves and pistons, which present relatively sharp edges that can cut or pierce food products during operation. Similarly, the pistons and central outlet valve can create similar issues. It would therefore be desirable to provide an improved food pump which has all of the desirable characteristics of the prior pump, while minimizing product disruptions.

References describing food pumps include US and foreign Patents and Publications Nos. U.S. Pat. Nos. 3,456,285, 3,887,964, 4,167,374, 4,431,384, 4,863,317, 4,884,594, 5,464,338, 5,474,101, 5,553,985, 5,688,534, 6,467,403, 7,182,224, 7,225,554, 2013/0248026, and GB 1547407, and Busch Machinery product brochure.

### SUMMARY OF THE INVENTION

The present invention overcomes the problems outlined above and provides pumping assemblies for use in food or related pumps, which largely resolve food disruption issues. Broadly speaking, such pumping assemblies include an elongated, normally upright, stationary, tubular valve body presenting a material inlet end configured to be coupled with a source of material to be pumped (e.g., a hopper), a material outlet end for directing pumped material to an outlet device, and a pump opening. An elongated, stationary, tubular pumping chamber is operatively connected with the pump opening of the tubular body. A four-port valve spool is located within the tubular body and presents an arcuate outer surface; the spool has a material inlet port, a pumped material outlet port, first and second operating ports, a first passageway interconnecting the first operating port and the material inlet port, and a second passageway interconnecting the second operating port and the material outlet port. A piston is located within the pumping chamber and is shiftable between a fill position, a compression position, and a discharge position. Importantly, the piston has an arcuate face closely complemental with the arcuate outer surface of the spool, which creates a piston cleaning action as the spool rotates; moreover, this eliminates the possibility of product collection between the piston face and spool.

A drive is operably coupled with the spool for selective shifting of the spool between a pumping chamber fill position where the spool first operating port is in communication with the pumping chamber, and a material discharge position where the second operating port is in communication with the pumping chamber. The piston is operable to shift within the pumping chamber when the spool is in the pumping chamber fill position in order to introduce material into the pumping chamber from the source through the first passageway, and to discharge the material within the pumping chamber through the second passageway when the spool is in the discharge position.

Additionally, the spool of the preferred pumping assembly has an imperforate surface between the first and second operating ports. This surface is of a size to completely block the pump opening of the tubular body. Accordingly, the spool is shifted to an intermediate position between the fill and discharge positions, in order to allow the piston to recompress a charge of material within the pumping chamber prior to discharge thereof. such pre-compression serves to increase the accuracy of the weight or volume of material to be delivered.

### BRIEF DESCRIPTION OF THE DRAWINGS

FIG. 1 is a perspective view of a pumping unit in accordance with the invention, illustrating the output end of the unit;

FIG. 2 is another perspective view of the pumping unit, depicting the opposite end thereof, as compared with FIG. 1;

FIG. 3 is a perspective view illustrating the dual pumping assemblies forming a part of the unit;

FIG. 4 is an exploded view illustrating the internal spool and other components of one of the pumping assemblies;

FIG. 5 is a vertical sectional view illustrating one of the pumping assemblies during introduction of material to be pumped into the pumping chamber thereof;

FIG. 6 is a horizontal sectional view of the pumping assembly of FIG. 5;

FIG. 7 is a vertical sectional view illustrating one of the pumping assemblies during compression of the material within the pumping chamber thereof;

FIG. 8 is a horizontal sectional view of the pumping assembly of FIG. 7;

FIG. 9 is a vertical sectional view illustrating one of the pumping assemblies during discharge of material therefrom;

FIG. 10 is a horizontal sectional view of the pumping assembly of FIG. 9;

FIG. 11 is a perspective view similar to FIG. 1, but depicting the hopper assembly shifted away from the pumping assemblies to allow for maintenance or cleanup; and

FIG. 12 is a side elevational view of the unit illustrated in FIG. 11.

### DETAILED DESCRIPTION OF THE PREFERRED EMBODIMENT

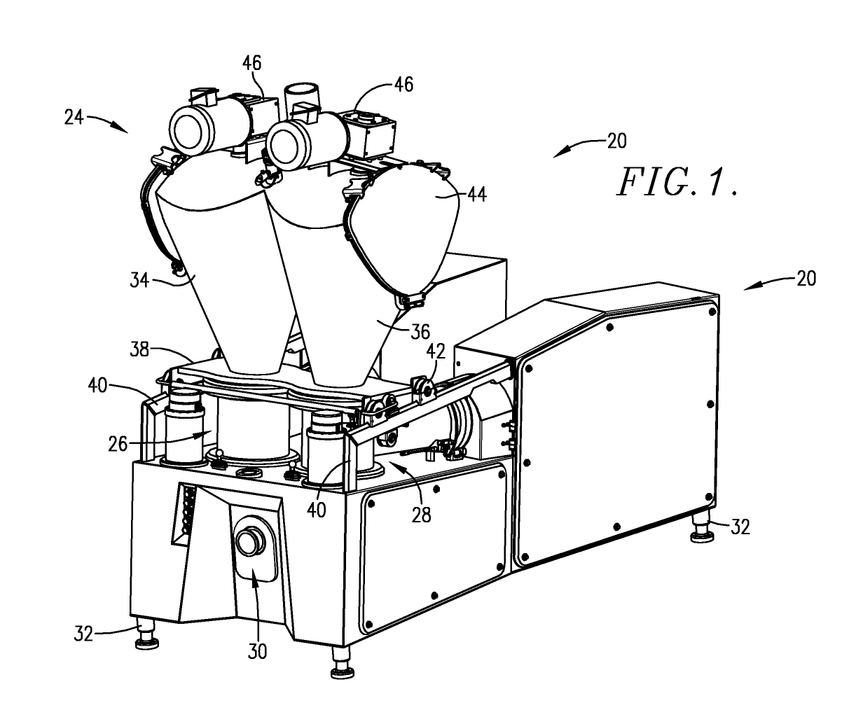

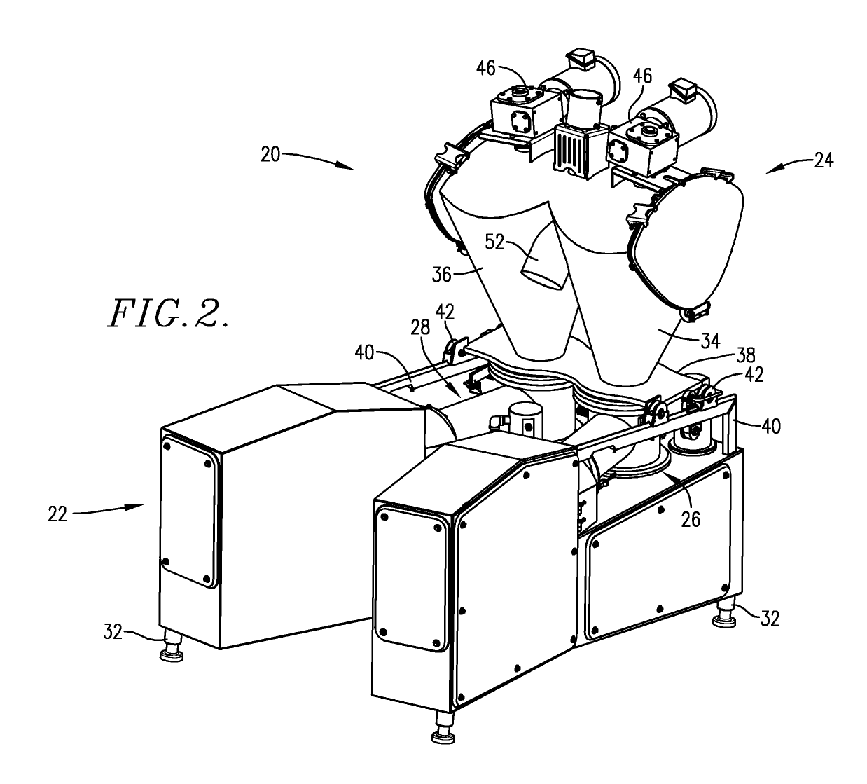

Turning now to the drawings, a pumping unit 20 is depicted in FIGS. 1 and 2 and broadly includes a bifurcated housing assembly 22, a hopper assembly 24, and a pair of identical pumping assemblies 26 and 28. The unit 20 is designed to receive flowable materials, such as meat or other comestible products, and to accurately pump portions of the materials via an outlet 30 for downstream processing.

The housing assembly 22 is itself conventional, and has leveling feet 32 with internal space to house drives and electrical control circuitry for the overall unit. The hopper assembly 24 includes a pair of identical, upright, conical material hoppers 34 and 36 mounted on a carriage 38. The latter is supported on side rails 40 and rollers 42, thereby permitting fore-and-aft shifting of the entire hopper assembly. Each hopper 34, 36 has an openable lid 44, as well as an augur drive assembly 46 for selective rotation of an internal augur 48 within the hopper (FIG. 5). As illustrated, the uppermost margin of the augur flight 49 is equipped with an enlarged synthetic resin tip 49a; this minimizes any chance of product entering at the top outside of the flight edge and traveling downward, leaving marks on the product. Each hopper is also equipped with a vacuumizing assembly (not shown) allowing a vacuum to be drawn within the hopper. As best seen in FIG. 5, each hopper 34, 36 has a lowermost outlet opening 50 for delivery of material to the underlying pumping assemblies 26, 28, as will be explained. A common material input conduit 52 (FIG. 2) allows filling of each hopper with material to be pumped.

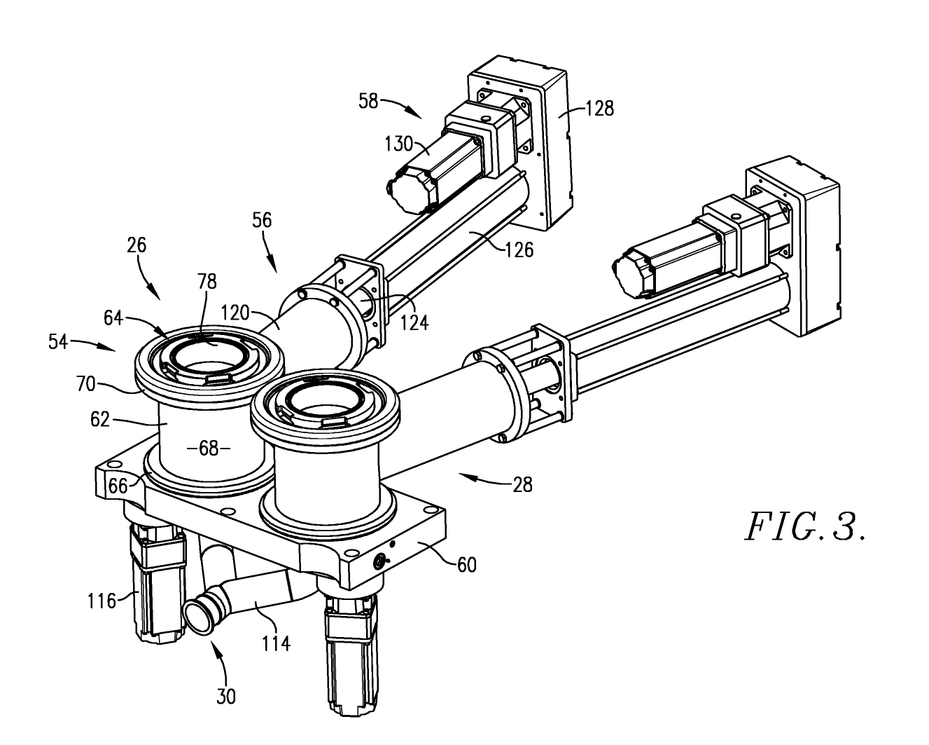

FIG. 3 depicts the pumping assemblies 26, 28 in perspective. Inasmuch as these assemblies are identical in structure and operation, only the assembly 26 will be described in detail, but this discussion is equally applicable to the assembly 28. Generally speaking, the assembly 26 includes a directional valve 54, a tubular pumping chamber 56, and a piston assembly 58. The valve 54 is supported on an apertured, stationary mounting block 60, whereas the remaining components of the assembly 26 are conventionally supported by components of housing assembly 22.

The valve 54 is a four-port, three-position directional or spool valve, and includes an upright, tubular valve casing or body 62 secured to block 60, as well as an internal spool assembly 64 within the body 62. The body 62 includes a lower connection flange 66 supporting an upright tubular sidewall 68 and an uppermost flange 70, thereby defining an upper material inlet end 72 and a lower output end 74. The sidewall 68 also has a pump opening 75 between the input and output ends 72, 74.

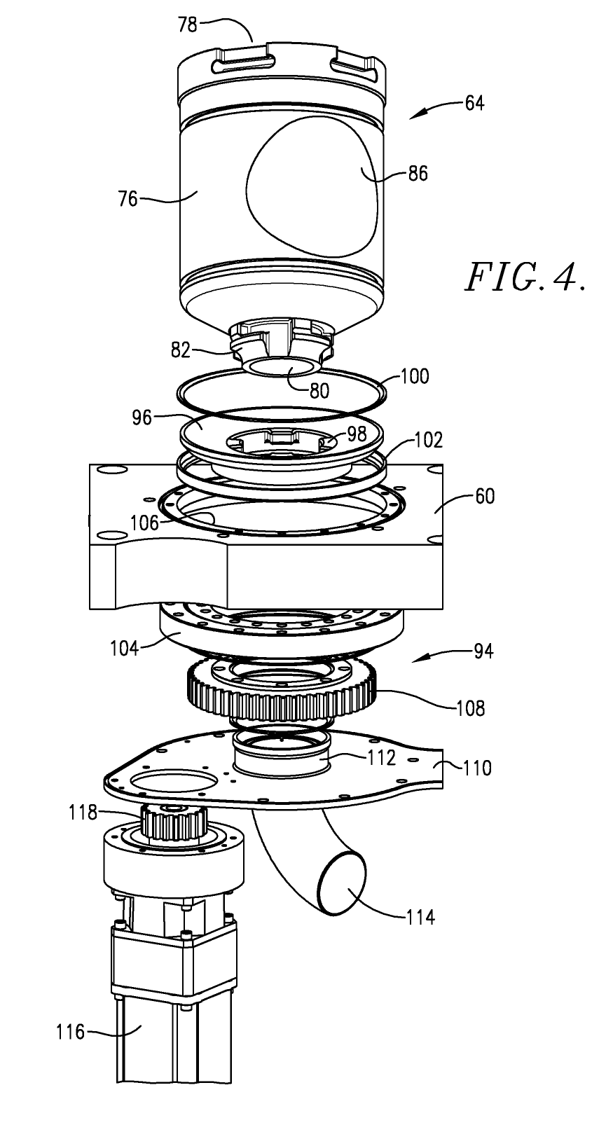

The spool assembly 64 is best understood from a consideration of FIGS. 4 and 5. This assembly includes and upright, cylindrical, rotary spool 76 having a topmost material inlet port 78 and a lowermost tubular outlet port 80, the latter equipped with outwardly projecting connecting lugs 82. The spool 76 includes a first operating port 84, a second operating port 86, and an arcuate imperforate surface 88 between the ports 84, 86. The spool 76 also has a first, smoothly arcuate internal passageway 90 extending from the inlet port 78 to first operating port 84, and a second, smoothly arcuate internal passageway 92 extending between the outlet port 80 and second operating port 86.

The spool assembly 64 is selectively rotated by means of a drive assembly 94. The assembly 94 includes a dished, annular drive plate 96 having locking lugs 98 designed to mate with the lugs 82, and a sealing ring 100 between the plate 96 and the lower periphery of spool 76. A secondary sealing ring 102 is located below the marginal edge of plate 96. An annular bearing 104 is located within a mounting hole 106 formed in block 60 and supports a drive gear 108. An apertured outlet plate 110, having an upstanding tubular connector 112, is disposed below gear 108 and supports a generally Y-shaped output tube 114, which couples with the unit output 30. An electric drive motor 116 depends from the plate 110 and includes a drive gear 118 located above the plate 110 and in meshed engagement with drive gear 118. Accordingly, upon actuation of motor 116, the spool 76 is rotated between the operational positions thereof, as will be described.

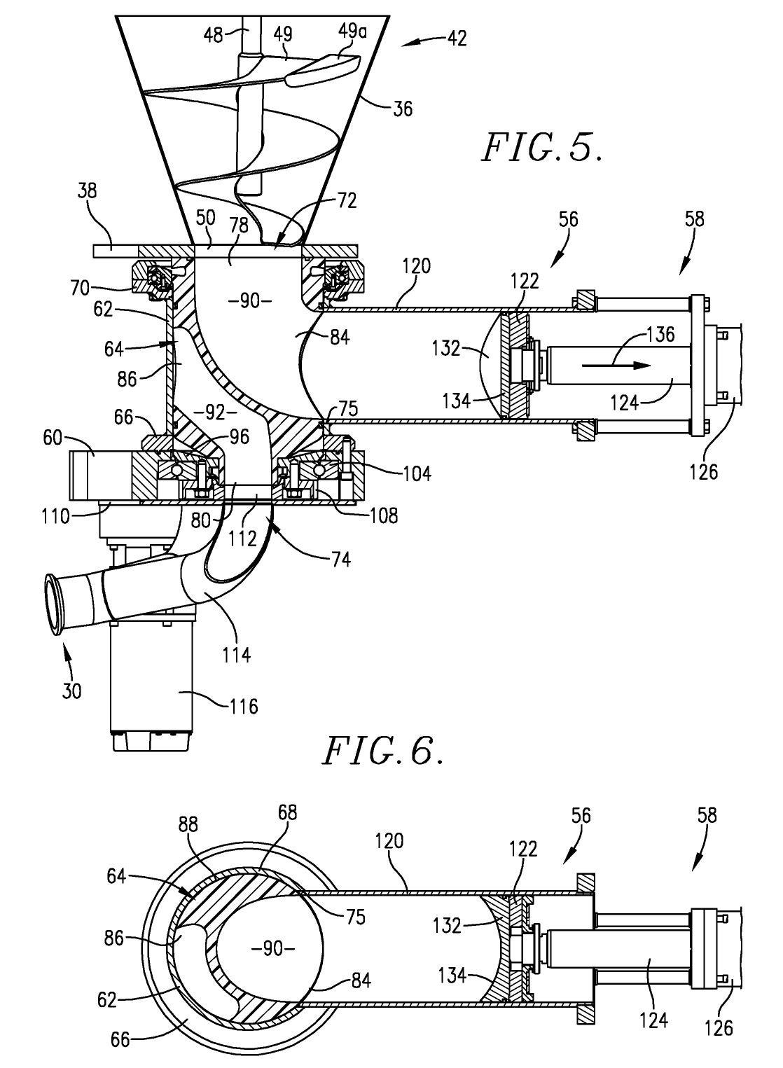

The pumping chamber 56 is in the form of an elongated, tubular, laterally extending component 120, which is secured to sidewall 68 in communication with the opening 75. The piston assembly 58 has a material-engaging piston 122 slidably received within the component 120, together with an elongated piston rod 124 extending rearwardly from the piston 122. The rod 124 is housed with a tubular chamber 126, and is coupled with a conventional drive (not shown) located within box 128. An electric screw drive motor 130 is connected to the drive within box 128. Actuation of the motor 130 serves to advance or retract the piston 122 within the tubular component 120. It will also be observed that the piston 122 includes an innermost face plate 132 (FIG. 6) having an arcuate, concave inboard face 134, which is substantially frustocylindrical in shape. The face 134 is complemental with the outer surface of spool 76, for purposes to be described.

### Operation

The operation of pumping assembly 26 will next be described, in sequential order wherein material is first withdrawn from the associated hopper 34 and introduced into the pumping chamber 56, followed by compression of the material within the chamber 56, and ultimate delivery of the compressed material to outlet tube 114. Referring first to the initial step (FIGS. 5-6), the spool 76 is rotated to a fill position wherein the first operating port 84 comes into registry with the pump opening 75. The piston 122 is then withdrawn within the component 120, as illustrated by directional arrow 136, thereby causing material from the hopper 34 to be drawn through first passageway 90, port 84, and opening 75, and then into the component 120 to create a charge of material of desired volume or weight.

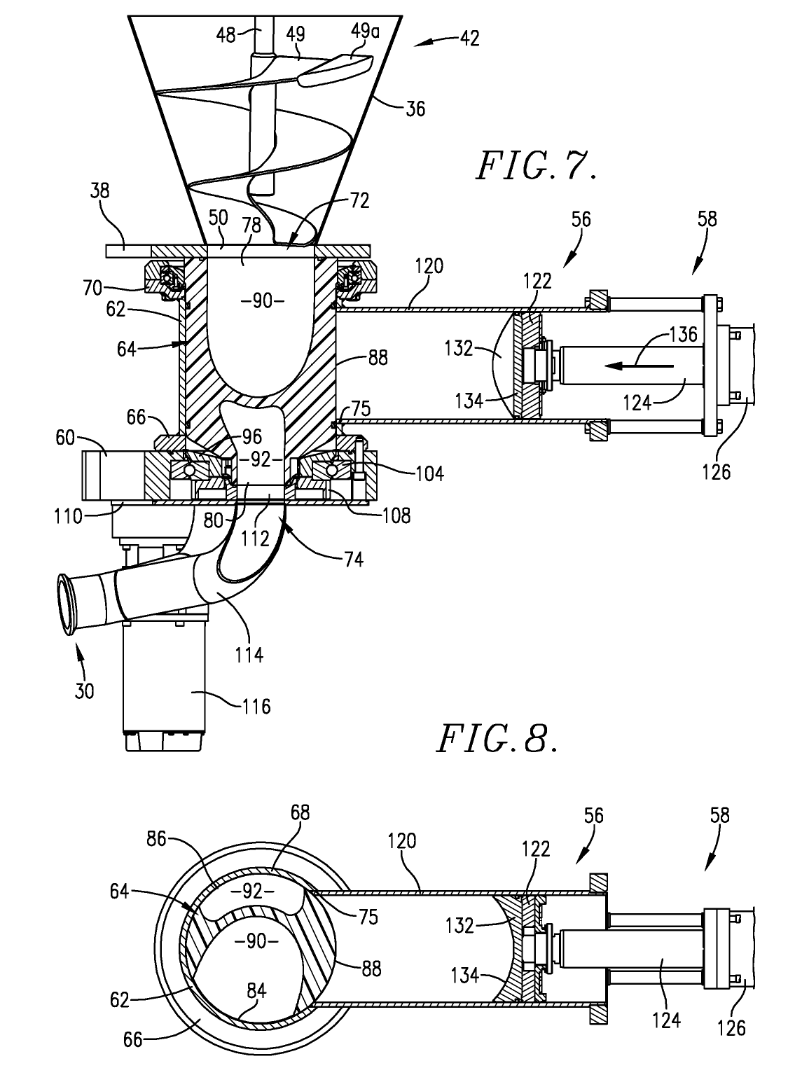

In the next step (FIGS. 7-8), the spool 76 is rotated to a material compression position wherein the imperforate spool surface 88 comes into registry with and fully covers the pump opening 75. The piston 122 is then advanced, as indicated by directional arrow 138, in order to compress the charge of material between piston 122 and surface 88 to a predetermined level. This ensures that the volumetric space between the piston face and surface 88 is constant during each pump cycle, which increases pumping accuracy.

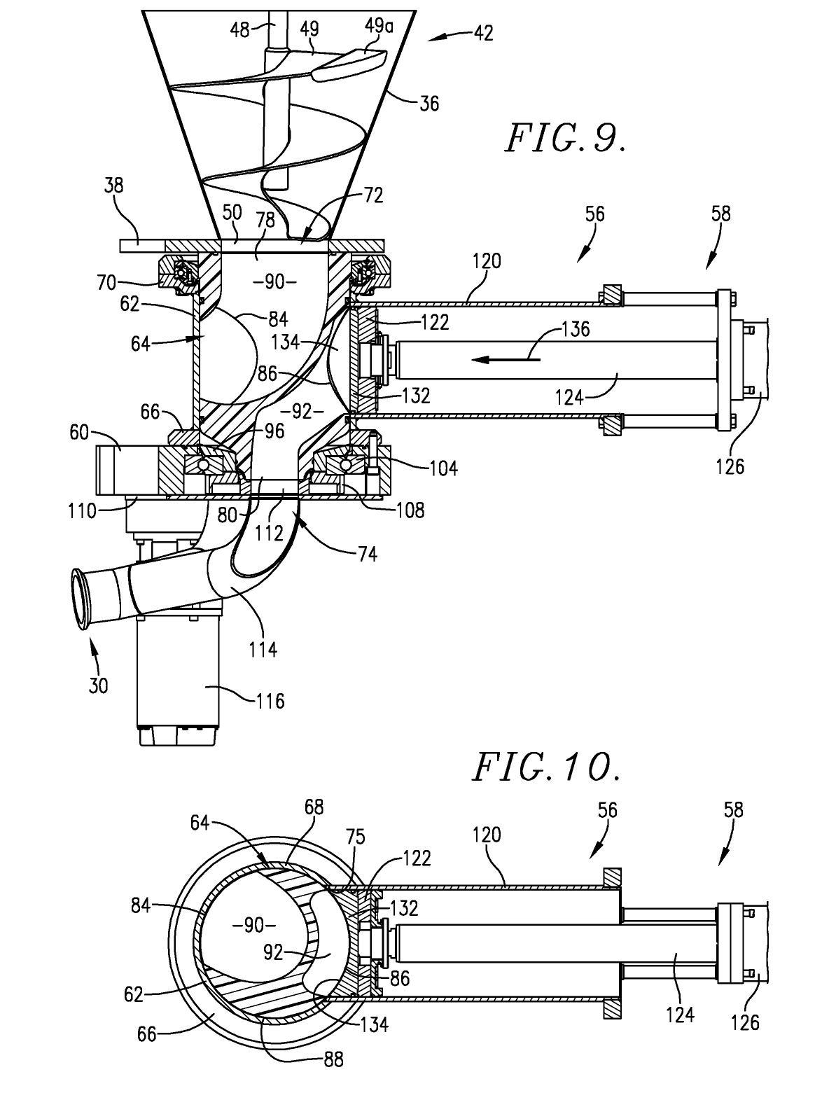

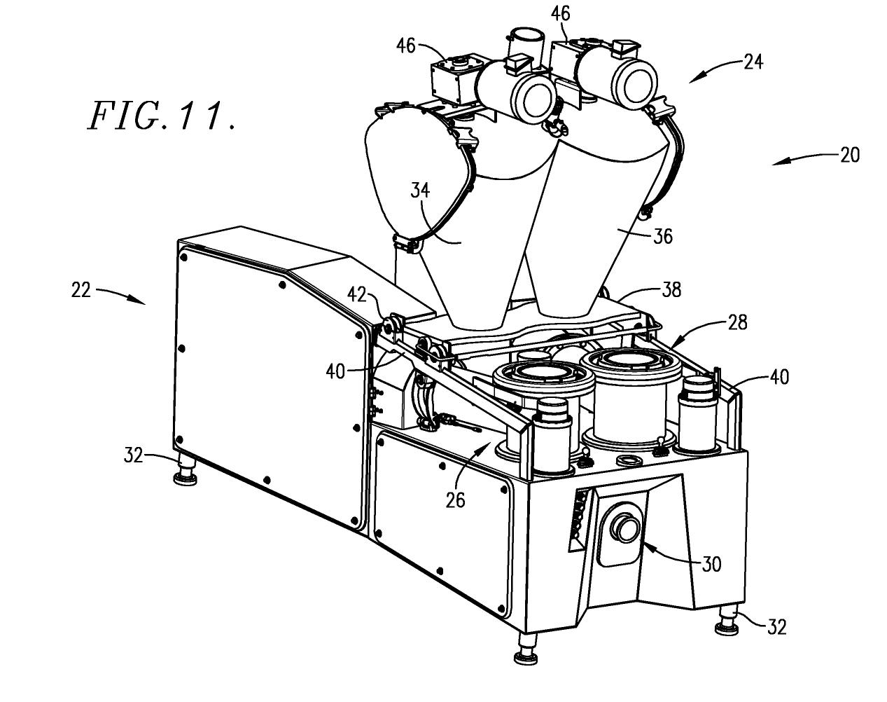

In the final step (FIGS. 9-10), the spool 76 is again rotated until the second operating port 86 comes into registry with opening 75. Advancement of the piston 122 in the direction of arrow 140 serves to move the pre-compressed charge of material through the second passageway 92, outlet port 80, connector 112, output tube 114, and then through outlet 30 for downstream processing. It will be observed that, during this final step, the concave piston face 134 comes into a very close mating relationship with the outer surface of spool 76, i.e., the clearance between the face 34 and spool 76 is on the order of a few thousandths of an inch, so that no significant amount of product remains between the piston face and spool. When the spool is next rotated in order to begin the pumping cycle, there is consequently very little tearing or smearing of the material being pumped. Furthermore, such post-discharge spool rotation is the only instance where product can be cut during the entire operation of the unit 20. Actual testing of the present invention confirms the presence of significantly less (43%) torn ham product during pumping operations, as compared with prior equipment illustrated in U.S. Pat. No. 5,479,847. This is a decided advantage versus prior pumping assemblies.

It will also be appreciated that the pumping assembly 28 operates in conjunction with the assembly 26 in a preselected relationship so that successive charges of material are delivered to the outlet 30 during operation of the pumping unit 20. This operation may be in an asynchronous or synchronous mode, to deliver either a continuous output or successive double loads to outlet 30.

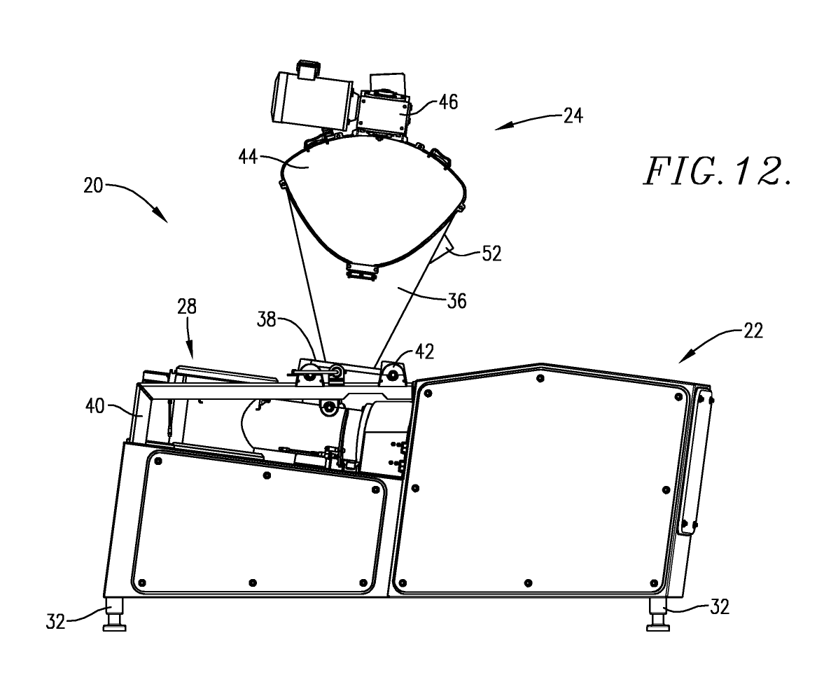

Additionally, the fact that the hoppers 34, 36 are mounted on carriage 38 allows the hoppers to be bodily moved in a fore-and-aft direction relative to the valves 54. Thus, as illustrated in FIGS. 1 and 2, the hopper assembly 24 may be moved to the operative position thereof where the hoppers communicate with the valve spools 76 during operation of the pumping unit 20. At the conclusion of a pumping run, the entire assembly 24 may be shifted to the position illustrated in FIGS. 11 and 12, in order to facilitate cleanup or repair of the pumping assemblies 26, 28.

I/We claim:

1. A pumping assembly, comprising:
an elongated, stationary, tubular body presenting a material inlet end configured to be coupled with a source of material to be pumped, a material outlet end for directing pumped material to an outlet device, and a pump opening;
an elongated, stationary, tubular pumping chamber operatively connected with said pump opening of said tubular body;
a spool within said tubular body having a material inlet port, a pumped material outlet port, first and second operating ports, a first passageway interconnecting said first operating port and said material inlet port, and a second passageway interconnecting said second operating port and said material outlet port, said spool presenting an arcuate outer surface;
a piston within said pumping chamber and shiftable between a fill position, a compression position, and a discharge position,
said piston having an arcuate face complemental with said arcuate outer surface of said spool; and
a drive operably coupled with said spool for selective shifting of the spool between a pumping chamber fill position where said spool first operating port is in communication with said pumping chamber, and a material discharge position where said second operating port is in communication with said pumping chamber,
said piston operable to shift within said pumping chamber when said spool is in said pumping chamber fill position in order to introduce material into the pumping chamber from said source through said first passageway, and to discharge said material within said pumping chamber through said second passageway when said spool is in said discharge position,
said piston face being in close adjacency to said spool arcuate surface in said discharge position thereof.

2. The pumping assembly of claim 1, said tubular body being upright, said pump opening located between said inlet and outlet openings.

3. The pumping assembly of claim 1, said spool being rotatable between said positions thereof.

4. The pumping assembly of claim 1, said first and second operating ports located between material and said material outlet of said tubular body.

5. The pumping assembly of claim 1, said spool having an imperforate surface between said first and second operating ports, said drive assembly operable to shift said spool to a material compression position where said imperforate surface covers said pump opening, said piston being shiftable to a material compression position with said imperforate surface covering said pump opening.

6. The pumping assembly of claim 1, said spool having a cylindrical outer surface, said piston face having a complemental frustocylindrical shape.

7. A pumping assembly, comprising:
an elongated, stationary, tubular body presenting a material inlet end configured to be coupled with a source of material to be pumped, a material outlet end for directing pumped material to an outlet device, and a pump opening;
an elongated, stationary, tubular pumping chamber operatively connected with said pump opening of said tubular body;
a spool within said tubular body presenting an outer surface and having a material inlet port, a pumped material outlet port, first and second operating ports, a first passageway interconnecting said first operating port and said material inlet port, and a second passageway interconnecting said second operating port and said material outlet port, said spool presenting an arcuate outer surface;
a piston within said pumping chamber and shiftable between a fill position, a compression position, and a discharge position; and
a drive operably coupled with said spool for selective shifting of the spool between a pumping chamber fill position where said spool first operating port is in communication with said pumping chamber, a material compression position where said imperforate surface covers said pump opening, and a material discharge position where said second operating port is in communication with said pumping chamber,
said piston operable to shift within said pumping chamber when said spool is in said pumping chamber fill position in order to introduce material into the pumping chamber from said source through said first passageway, to compress said introduced material within the pumping chamber when said spool is in said material compression position, and to discharge said compressed material through said second passageway when said spool is in said discharge position.

8. The pumping assembly of claim 7, said tubular body being upright, said pump opening located between said inlet and outlet openings.

9. The pumping assembly of claim 7, said spool being rotatable between said positions thereof.

10. The pumping assembly of claim 7, said first and second operating ports located between material and said material outlet of said tubular body.

11. A pumping unit, comprising:
structure defining a hopper for holding a material to be pumped;
a pumped material outlet device; and
a pumping assembly operably interposed between said hopper and said pumped material outlet device, said pumping assembly including—
an elongated, stationary, tubular body presenting a material inlet end operatively coupled with said hopper, and a material outlet end operatively coupled with said pumped material outlet device, and a pump opening;
an elongated, stationary, tubular pumping chamber operatively connected with said pump opening of said tubular body;
a spool within said tubular body having a material inlet port, a pumped material outlet port, first and second operating ports, a first passageway interconnecting said first operating port and said material inlet port, and a second passageway interconnecting said second operating port and said material outlet port, said spool presenting an arcuate outer surface;
a piston within said pumping chamber and shiftable between a fill position, a compression position, and a discharge position,
said piston having an arcuate face complemental with said arcuate outer surface of said spool; and
a drive operably coupled with said spool for selective shifting of the spool between a pumping chamber fill position where said spool first operating port is in communication with said pumping chamber, and a material discharge position where said second operating port is in communication with said pumping chamber,
said piston operable to shift within said pumping chamber when said spool is in said pumping chamber fill position in order to introduce material into the pumping chamber from said hopper through said first passageway, and to discharge said material within said pumping chamber through said second passageway when said spool is in said discharge position,
said piston face being in close adjacency to said spool arcuate surface in said discharge position thereof.

12. The pumping unit of claim 11, said tubular body being upright, said pump opening located between said inlet and outlet openings.

13. The pumping unit of claim 11, said spool being rotatable between said positions thereof

14. The pumping unit of claim 11, said first and second operating ports located between material and said material outlet of said tubular body.

15. The pumping unit of claim 11, said spool having an imperforate surface between said first and second operating ports, said drive assembly operable to shift said spool to a material compression position where said imperforate surface covers said pump opening, said piston being shiftable to a material compression position with said imperforate surface covering said pump opening.

16. The pumping unit of claim 11, said spool having a cylindrical outer surface, said piston face having a complemental frustocylindrical shape.

17. A pumping unit, comprising:
structure defining a hopper for holding a material to be pumped;
a pumped material outlet device; and
a pumping assembly operably interposed between said hopper and said pumped material outlet device, said pumping assembly including—
an elongated, stationary, tubular body presenting a material inlet end operatively coupled with said hopper, a material outlet end operatively coupled with said outlet device, and a pump opening;
an elongated, stationary, tubular pumping chamber operatively connected with said pump opening of said tubular body;
a spool within said tubular body presenting an outer surface and having a material inlet port, a pumped material outlet port, first and second operating ports, a first passageway interconnecting said first operating port and said material inlet port, and a second passageway interconnecting said second operating port and said material outlet port, said spool presenting an arcuate outer surface;
a piston within said pumping chamber and shiftable between a fill position, a compression position, and a discharge position; and
a drive operably coupled with said spool for selective shifting of the spool between a pumping chamber fill position where said spool first operating port is in communication with said pumping chamber, a material compression position where said imperforate surface covers said pump opening, and a material discharge position where said second operating port is in communication with said pumping chamber,
said piston operable to shift within said pumping chamber when said spool is in said pumping chamber fill position in order to introduce material into the pumping chamber from said hopper through said first passageway, to compress said introduced material within the pumping chamber when said spool is in said material compression position, and to discharge said compressed material through said second passageway when said spool is in said discharge position.

18. The pumping unit of claim 17, said tubular body being upright, said pump opening located between said inlet and outlet openings.

19. The pumping unit of claim 17, said spool being rotatable between said positions thereof.

20. The pumping unit of claim 17, said first and second operating ports located between material and said material outlet of said tubular body.
